(19) United States
(12) Patent Application Publication
(10) Pub. No.: US 2013/0053996 A1
(43) Pub. Date: Feb. 28, 2013

(54) METHOD OF PROGRAMMING RECIPE THROUGH GUI AND MEDIA RECORDING THE SAME

(71) Applicant: Chung-Yuan Wu, Kaohsiung City (TW)

(72) Inventor: Chung-Yuan Wu, Kaohsiung City (TW)

(21) Appl. No.: 13/221,605

(22) Filed: Aug. 30, 2011

(51) Int. Cl. G06F 19/00

(52) U.S. Cl. 700/100

(57) ABSTRACT

A method of programming a recipe through a GUI and a media recording the same applied to process recipe editing for semiconductor/photoelectric equipment includes: providing the GUI comprising a template area and a working area, wherein the template area has a plurality of control objects and/or a plurality of macro objects; and the working area has a chart; defining a plurality of procedures of the recipe on the chart; defining required objects of the recipe by dragging the required objects from the control objects and the macro objects into the chart to form a characteristic curve with an initial value for each object; and setting a control parameter of each characteristic curve in each procedure, wherein the control parameter comprises a slope and at least a setting point. By dragging on a chart, a process personnel performs scheduling of the process recipe intuitively, thereby reducing the development and debugging time.

### BACKGROUND OF THE INVENTION

1. Field of the Invention

The present invention relates to a programming method of a recipe, and more particularly to a method of programming a process recipe applied in equipment in semiconductor or photoelectric industry through a graphical user interface.

2. Description of the Prior Art

In the fields of semiconductor and photoelectric equipment, designers for fabrication processes perform tasks such as data packaging, macro, command delivery, data structure encoding and decoding, warning message alert, process file management and history event logging through a human machine interface and a controller on the equipment side. During conventional process development, there are usually two development modes available for planning the required hardware components and for scheduling the complicated processes, one through form filling, and the other through text programming. The first form-filling programming method involves filling items which can be classified into macro commands or component names, operator commands, parameter settings, and execution time settings; the second text programming method involves programming under a language similar to C/C++/VB, and therefore requires the fabrication process developer to be familiar with the syntax of the language in order to enjoy the design freedom.

### SUMMARY OF THE INVENTION

The present invention provides a method of programming a recipe through a graphical user interface (GUI) and the media recording the same. By using the graphical programming method, scheduling of a process recipe is performed intuitively, thereby reducing the development and debugging time of a process personnel.

According to an embodiment, A method of programming a recipe through a graphical user interface (GUI) applied to process recipe editing for semiconductor equipment or photoelectric equipment, wherein the method includes the following procedures: providing the GUI comprising a template area and a working area, wherein the template area has a plurality of control objects and/or a plurality of macro objects; and the working area has a chart, of which a first axis represents time and a second axis represents a physical quantity or condition; defining at least one procedure of the process recipe on the chart; defining required objects of the process recipe by dragging the required objects from the plurality of control objects and the plurality of the macro objects into the chart to form a characteristic curve with an initial value for each object; and setting a control parameter of each characteristic curve in each procedure, wherein the control parameter comprises a slope, and at least a setting point.

According to another embodiment, A computer readable medium storing a computer program loadable by a device to execute a method of programming a recipe through a graphical user interface applied to process recipe editing for semiconductor equipment or photoelectric equipment, wherein the method includes the following procedures: providing the GUI comprising a template area and a working area, wherein the template area has a plurality of control objects and/or a plurality of macro objects; and the working area has a chart, of which a first axis represents time and a second axis represents a physical quantity or condition; defining at least one procedure of the recipe on the chart; defining required objects of the recipe by dragging the required objects from the plurality of control objects and the plurality of the macro objects into the chart to form a characteristic curve with an initial value for each object; setting a control parameter of each characteristic curve in each procedure, wherein the control parameter comprises a slope and at least a setting point.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

FIG. 1 is a flow chart illustrating the method of programming the recipe through the GUI according to an embodiment of the present invention;

FIG. 2 and FIG. 3 are schematic diagrams illustrating the GUI of the method of programming the recipe through the GUI according to an embodiment of the present invention;

FIG. 4 is a flow chart illustrating the method of programming the recipe through the GUI according to an embodiment of the present invention; and

FIG. 5 is a flow chart illustrating the verification procedure of the method of programming the recipe through the GUI according to an embodiment of the present invention.

### DESCRIPTION OF THE PREFERRED EMBODIMENT

The detailed explanation of the present invention is described as follows. The described preferred embodiments are presented for purposes of illustrations and description, and are not intended to limit the scope of the present invention.

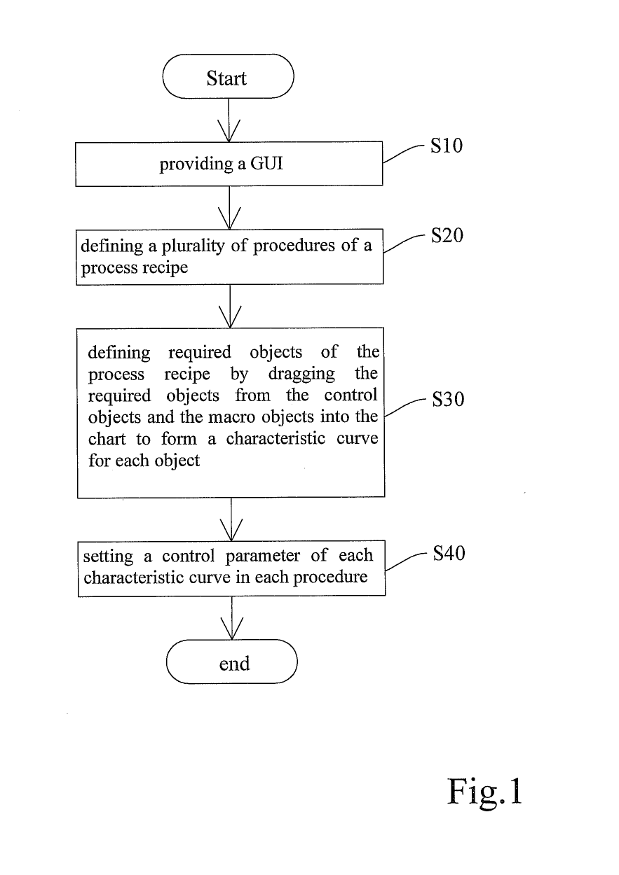

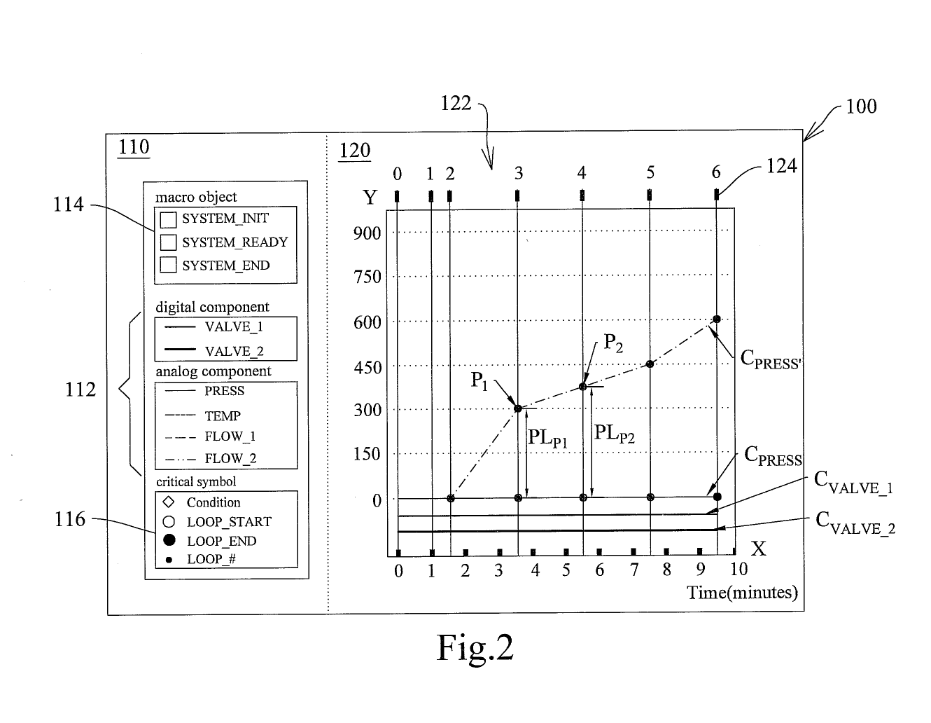

Referring first to FIG. 1 and FIG. 2, there are respectively illustrated a flow diagram of a method of programming a recipe through a graphical user interface (GUI) according to an embodiment, and a schematic diagram illustrating the GUI according to an embodiment. The method of programming the recipe through the GUI may be applied to process recipe editing for semiconductor or photoelectric equipment. As illustrated in FIG. 1 and FIG. 2, the programming method includes the following procedures. First, a GUI 100 is provided (S10). The GUI 100 includes a template area 110 and a working area 120, wherein the template area 110 contains a plurality of control objects 112 and/or a plurality of macro objects 114. The working area 120 has a chart 122, of which a first axis X represents time, and a second axis Y represents a physical quantity or condition of a process recipe. Next, at least a procedure of the process recipe is defined (S20). According to an embodiment, the method for defining a procedure in the process recipe includes setting the time required for the procedure. Because the process recipe here may include a plurality of procedures, a plurality of nodes 124 may be disposed above the chart 122, showing the sequence for the procedures. Thereafter, required objects of the process recipe are defined by dragging the required objects from the plurality of control objects 112 and the plurality of macro objects 114 into the chart 122 to form a characteristic curve Cᵢ with an initial value for each object (S30). The subscript i here is to be replaced by the relevant object. For example, the symbol C_{PRESS} in the figure corresponds to the characteristic curve of a pressure component PRESS, with an initial value. It can be understood that the object may also be selected to be placed in the chart 122 by way of clicking or checking. Finally, a control parameter of each characteristic curve in each procedure is set, wherein the control parameter may include a slope and at least a setting point (S40). It can be understood that the programming method can be utilized to not only create a new process recipe, but also adjust a specified existing process recipe.

Continued from the above description and illustrated in FIG. 2, the control object 112 in the template area 110 according to an embodiment may include digital components and analog components, wherein the control parameter further comprises a condition, and the condition of the digital component, which may be a valve switch, control flag and the like, may be represented by Boolean values (TRUE/FALSE); the setting of the analog component, which may be a pressure controller, temperature controller, flow controller and the like, may be represented by a number within a limited range. The macro object 114 is a sub-program which can be pre-scheduled. Highly repetitive procedures can be implemented with macros. In addition, the macro object 114 may include multiple macros. According to an embodiment, the template area 110 further includes a plurality of critical symbols 116 for indicating the control flow in the process recipe, wherein the critical symbol 116 may include a condition symbol, a loop start symbol, and a loop end symbol.

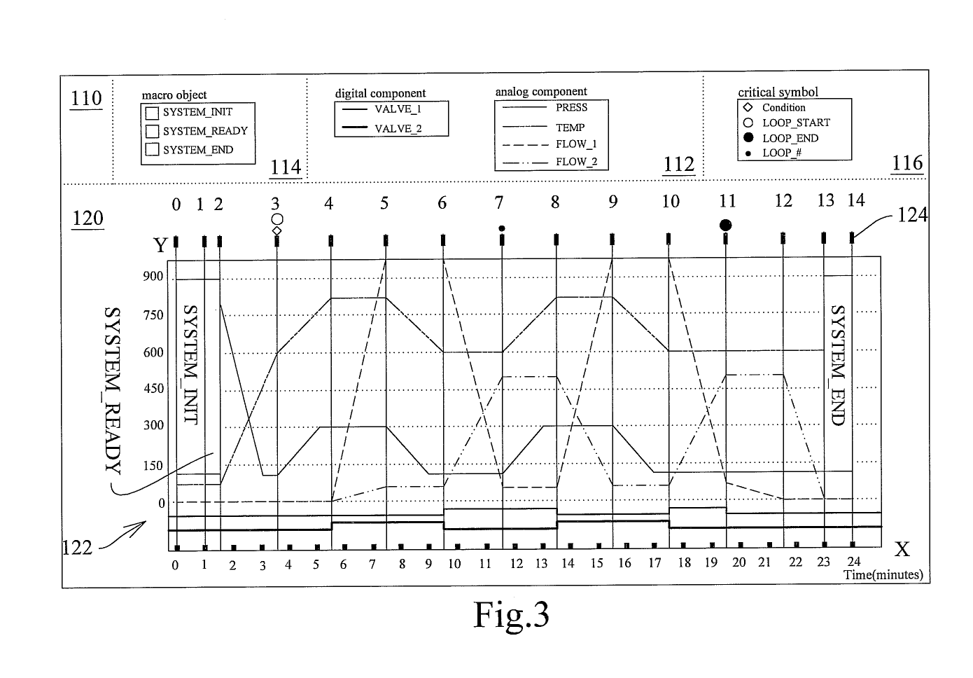

In the aforementioned procedure S30, the method for setting control parameters include dragging the characteristic curve C₁ to adjust its slope and its two setting points P₁, P₂ to change their projection lengths PLₚ₁, PLₚ₂ to the first axis X, such as dragging the characteristic curve C_{PRESS} to adjust it to be the characteristic curve C_{PRESS}′. In this embodiment, the second axis Y of the chart 122 in the working area 120 could be changed to the physical quantity or condition of the process recipe corresponding to the characteristic curve Cᵢ under edit. For example, when the characteristic curve under edit represents temperature, then the unit of the second axis Y can be changed to temperature units such as ° C. or ° F. and the appropriate scale in real time; when the characteristic curve under edit represents pressure, then the unit of the second axis Y can be altered to pressure units such as Torr and the appropriate scale in real time. For the convenience of differentiating different characteristic curves, the characteristic curves in the working area 120 may be displayed in different colors, different line styles, or different line widths, as exemplified in FIG. 3. It can be understood that the working area 120 may also include more than one chart, wherein a single characteristic curve may be drawn in a single chart, or wherein a plurality of characteristic curves with the same unit for the second axis Y or a plurality of relevant characteristic curves may be drawn in the same chart. During the process of designing the process recipe, if a procedure is found missing an object, the programming method according to an embodiment may further include adding a new control object or macro object into the procedure of process recipe by way of insertion. On the other hand, an unnecessary characteristic curve may be removed by way of deletion.

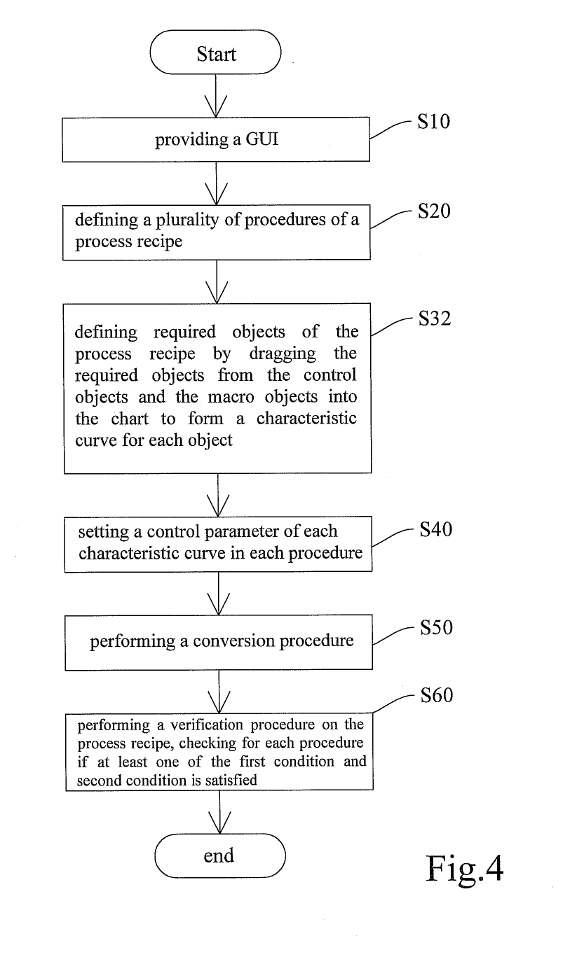

Referring to FIG. 4, the programming method according to an embodiment may further include a conversion procedure (S50) after the editing for process recipe is finished for converting all the characteristic curves and the corresponding control parameters in the chart into source code in text format or form format, or into object code that is readable by semiconductor or photoelectric equipment for subsequent computer processing. Thereafter, the programming method according to an embodiment further includes a verification procedure (S60), wherein the verification procedure includes checking for each procedure if at least one of a first condition and a second condition is satisfied. The first condition is the control parameter of each characteristic curve in the procedure is reasonable. According to an embodiment, checking for the first condition includes determining if the slope of each characteristic curve is within a threshold, and determining if the setting point of each characteristic curve is between a high bound threshold and a low bound threshold. The threshold, the high bound threshold, the low bound threshold, and the initial value of the characteristic curve Cᵢ (as shown in FIG. 2) can be set during the machine setting initialization procedure of the semiconductor or photoelectric equipment. The second condition is the characteristic curves in the procedure of the process recipe are ordered correctly. The second condition is checked to comply with the safety standard.

Steps for checking the first/second conditions in the verification procedure in an embodiment are described in detail in the following. The verification procedure comprises checking for each procedure if the slope of each characteristic curve is positive and the slop is set to comply with the equipment specification. For example, the verification procedure comprises checking if the ramp up/down rate of the pressure in the chamber exceeds 100 mbar per second (100 mbar is the threshold of the pressure curve); checking if the ramp up/down rate of the temperature in the chamber exceeds 20° C. per second (20° C. is the threshold of the temperature curve); checking if the rotational ramp up/down rate of the susceptor exceeds 40 rpm per second (40 rpm is the threshold); checking if the ramp up/down rate for the air admission in the chamber exceeds 10 SLM per second (10 SLM is the threshold), and so on. The abovementioned restriction condition for each ramp up/down rate is not an absolutely fixed constant, and it can be set according to a safety limit of the equipment by the process personnel. In addition, the setting point of each characteristic curve in the procedure can be checked to determine if the setting point is between the high bound threshold and the low bound threshold. In one embodiment, the high bound threshold of the pressure in the chamber can be set to 1333 mbar and the low bound threshold can be set to 50 mbar; the high bound threshold of the temperature in the chamber can be set to 1500° C. and the low bound threshold can be set to 0° C.; the high bound threshold of the rotation rate for the susceptor can be set to 200 rpm and the low bound threshold can be set to 5 rpm; the high bound threshold of the intake air flow for the procedure can be set to 50 SLM and the low bound threshold can be set to 1 SLM, and so on. The abovementioned high/low bound threshold which can be set according to a safety limit of the equipment by the process personnel is not an absolutely fixed constant value. Moreover, the verification procedure comprises checking for each procedure if the characteristic curves are ordered correctly. For instance, checking if the valve of the cooling system is open before ramping up the temperature in the chamber; checking if the power supply is turned on before ramping up/down the temperature in the chamber; checking if the rotation rate of the susceptor exceeds the low bound threshold before ramping up/down the temperature in the chamber; checking if the pump is turned on and the pressure control valve is set in a automatic mode before implementing the pressure control procedure; and checking if the solenoid valves of the N₂ supply source and the cooling water source are turned on before pumping. According to the EC (equipment confirm) mechanism, all the procedures in the process recipe can be controlled by the process personnel to comply with the safety standard.

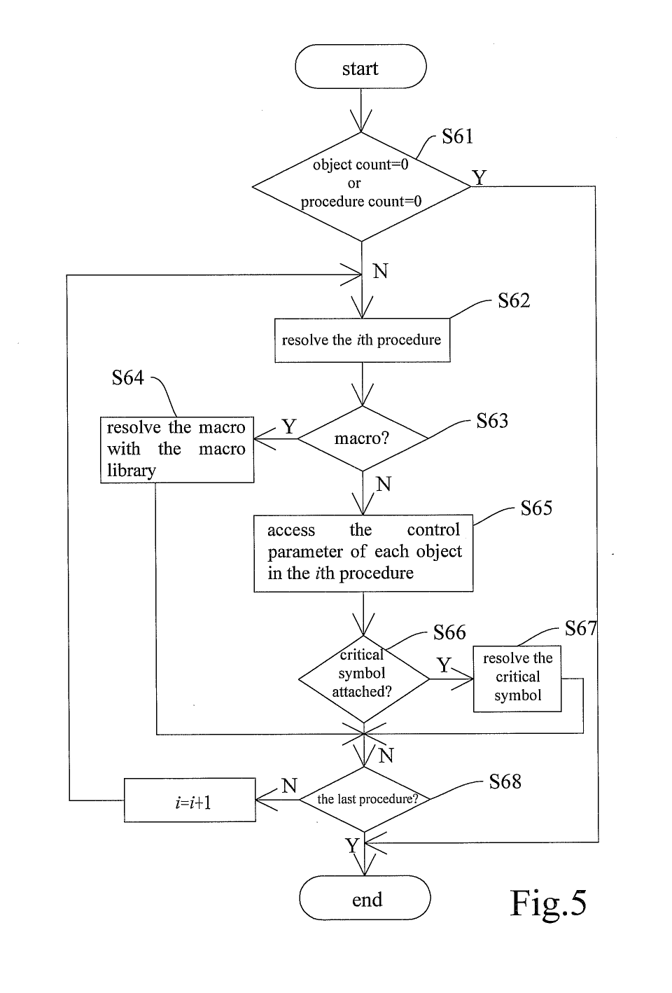

Continued from the above description, the verification procedure according to an embodiment is illustrated in the detail flow chart shown in FIG. 5. First, the objects and the procedures involved in a process recipe are determined (S61). Next, the ith procedure is resolved (S62). Thereafter, whether the procedure of the process recipe includes a macro object is determined (S63). If so, the macro object is resolved according to a macro library (S64) and an implementation result of the macro object is stored at a specific address of the computer memory. If not, the control parameter of each characteristic curve in the procedure is verified (S65). Then, whether the chart has any critical symbol is determined (S66). If so, the critical symbol is resolved (S67). If not, whether the procedure verified is the last procedure is determined (S68). The procedures S62 to S68 are repeated until all the procedures in the process recipe are finished with verification. Those failed verification would be marked on the chart as error positions to facilitate the process personnel to perform debugging and modification, and to repeat verification until each procedure of the process recipe is error free. Once the verification procedure is completed, a report summarizing the parameters and time set by the process personnel and the result thereof may be generated, thereby allowing an effective management for convenience of future classification of process files. Programming the procedures of the process recipe through the GUI is intuitive to the process personnel. No prior learning of specific programming language is required. Therefore, the development and debugging time of the process personnel may be effectively reduced. Moreover, scheduling convenience is enhanced for the process personnel.

The process recipe completed by using the method of the present invention may be executed on the semiconductor equipment or photoelectric equipment in an off-line mode or on-line mode. If the off-line mode is selected, the real situation would be simulated, and a feedback signal based on the process recipe would be produced according to the condition of each characteristic curve. The feedback signal is a pseudo signal, and would not control a physical object. If abnormality is found in the recipe during the simulation process, modification to the recipe can be made by returning to the working area and modifying the chart. On the other hand, if the on-line mode is selected, then the finished process recipe would be uploaded as data packets to the control component, and when the process recipe is executed, a feedback signal based on the process recipe would be produced according to the condition of the control object, which would actually control the physical object until the process recipe ends. If any man-made or non man-made abnormality occurs during the process, then the process recipe is forced to end.

The embodiment below illustrates the spirit of the present invention. Referring still to FIG. 2, the embodiment here involves the GUI 100 as described above, which can be divided into a template area 110 and a working area 120. The template area 110 contains various kinds of objects, such as control objects 112, macro objects 114, critical symbols 116 and the like, which afford the process personnel various selections. The working area 120 on the right has a chart 122, of which the horizontal axis represents time, and the vertical axis corresponds to a physical quantity or condition. The process personnel may first roughly set the time required for each procedure in the process recipe and dispose a node 124 above the chart to mark the start and end of each procedure (the end of the procedure can be represented by the start of the next procedure). The node for each procedure can be arbitrarily modified, inserted or deleted. As illustrated in FIG. 2, the process personnel inserts a first procedure at the 1st minute, a second procedure at the 1.5th minute and etc. A total of six procedures are set. Next, the process personnel may drag, click or check the pressure object PRESS, the valve switches VALVE_1 and VALVE_2 in the template area 110 to form characteristic curves Cᵢ in the working area respectively corresponding to the objects. It is noted that each object may be modified, inserted, or deleted similar to the node 124 according to needs. Then, the respective control parameter of each characteristic curve in each procedure can be set by dragging the characteristic curve initialized as e.g. the curve C_{PRESS} to change it to the curve C_{PRESS}′ with the desired slopes and projection lengths to the time axis.

Referring to FIG. 3, there is illustrated a chart 122 of a process recipe according to an embodiment. As illustrated in the figure, the process recipe has 14 procedures which require 24 minutes in total. Macro objects SYSTEM_INT and SYSTEM_READY are inserted in the first and the second procedures to initialize the system by the process personnel. Then, in the second procedure, a pressure control object PRESS would spend 1.5 minutes to have the atmospheric pressure controlled to be at 100 Torr; a temperature object TEMP would spend 2 minutes to have the temperature raised from room temperature to 600° C.; and in the third procedure, a condition symbol “⋄ Condition” is inserted for determining whether the temperature object TEMP is greater than 580° C., and a loop start symbol “∘ LOOP_STRAT” and a loop end symbol “ LOOP_END” are added as an indication that there would be repeated procedures in the following of the recipe. The process personnel may repeat the foregoing procedures to complete all the procedures in the process recipe. The method of programming the recipe through the GUI allows the process personnel to assign the timing of the objects within a specified time frame by drawing, and to perform programming in an intuitive manner, and therefore cannot only raise the readability of a process recipe, but can also decrease the development and debugging time of the process personnel. It can be understood that the arrangement of the GUI illustrated in FIG. 2 and FIG. 3 are only one example, and are not intended to be used to limit the present invention.

The method of programming the recipe through a GUI of the present invention also provides a verification method for the process recipe made as described above, to ensure that all the control parameters in each procedure of the process recipe comply with the safety standard of the equipment. The flow of the verification procedures is similar to that illustrated in FIG. 5 and is omitted here.

According to an embodiment, a computer readable media records a computer program which can be loaded on a device to execute the method of programming the recipe through the GUI illustrated in FIG. 1. The detail implementations of the procedures have been described above and are omitted here.

To summarize the foregoing description, the method of programming the recipe through GUI according to the present invention allows a process personnel to intuitively perform process recipe scheduling through a GUI and dragging actions, thereby reducing the development and debugging time of the process personnel. More specifically, the method of the present invention achieves the following advantages:

1) Various parameters of all the control components are laid out in characteristic curves and organized in a chart, greatly enhancing the readability of the process recipe;

2) Errors found in the verification process of the finished process recipe may be marked in the chart, facilitating the process personnel to perform debugging and modification; and

3) There is no need for the process personnel to learn the specific syntax of a programming language from scratch, significantly reducing the time spent for educating developers.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A method of programming a recipe through a graphical user interface (GUI) applied to process recipe editing for semiconductor equipment or photoelectric equipment, wherein the method includes the following procedures:
providing the GUI comprising a template area and a working area, wherein the template area has a plurality of control objects and/or a plurality of macro objects; and the working area has a chart, of which a first axis represents time and a second axis represents a physical quantity or condition;
defining at least one procedure of the recipe on the chart;
defining required objects of the recipe by dragging the required objects from the plurality of control objects and the plurality of the macro objects into the chart to form a characteristic curve with an initial value for each object; and
setting a control parameter of each characteristic curve in each procedure, wherein the control parameter comprises a slope and at least a setting point.

2. The method according to claim 1, wherein the plurality of control objects comprise at least one digital component and at least one analog component; and the control parameter further comprises a condition.

3. The method according to claim 1, wherein the second axis can be changed to the physical quantity or the condition of the recipe corresponding to the characteristic curve under edit.

4. The method according to claim 1, wherein the method of setting the control parameter comprises dragging the characteristic curve to adjust a slope thereof and a projection length to the first axis thereof.

5. The method according to claim 1, wherein the working area comprises a plurality of nodes for marking the start and end of the procedure.

6. The method according to claim 1, further comprising performing a verification procedure on the recipe, wherein the verification procedure comprises checking for each procedure if at least one of the first condition and second condition is satisfied, the first condition being each control parameter of the procedure of the recipe is reasonable, and the second condition being the order of the characteristic curves is correct.

7. The method according to claim 6, wherein the verification procedure further comprises determining if the procedure of the recipe comprises any macro object, and if so, resolving the macro object.

8. The method according to claim 6, wherein checking for the first condition comprises determining if the slope of each characteristic curve is smaller than a threshold; and determining if the setting point of each characteristic curve is between a high bound threshold and a low bound threshold.

9. The method according to claim 8, wherein the threshold, the high bound threshold and the low bound threshold are set in a machine setting initialization procedure of the semiconductor equipment or the photoelectric equipment.

10. The method according to claim 6, wherein if the recipe fails the verification procedure, each error position is marked on the chart.

11. The method according to claim 1, wherein the template area further comprises a plurality of critical symbols which can be set to indicate the control flow in the recipe; and the critical symbol comprises a condition symbol, a loop start symbol, and a loop end symbol.

12. The method according to claim 1, further comprises adding to the procedure of the recipe an additional control object or macro object by way of insertion.

13. The method according to claim 1, wherein each characteristic curve in the working area has a different color, a different line style, or a different line width.

14. The method according to claim 1, further comprising a conversion procedure for converting each characteristic curve in the chart and the corresponding control parameter into source code in text format or form format, or into object code readable by the semiconductor equipment or the photoelectric equipment.

15. A computer readable medium storing a computer program loadable by a device to execute a method of programming a recipe through a GUI applied to process recipe editing for semiconductor equipment or photoelectric equipment, wherein the method includes the following procedures:
providing the GUI comprising a template area and a working area, wherein the template area has a plurality of control objects and/or a plurality of macro objects; and the working area has a chart, of which a first axis represents time and a second axis represents a physical quantity or condition;
defining at least one procedure of the recipe on the chart;
defining required objects of the recipe by dragging the required objects from the plurality of control objects and the plurality of the macro objects into the chart to form a characteristic curve with an initial value for each object;
setting a control parameter of each characteristic curve in each procedure, wherein the control parameter comprises a slope and at least a setting point.

16. The computer readable medium according to claim 15, wherein the plurality of control objects comprise at least one digital component and at least one analog component; and the control parameter further comprises a condition.

17. The computer readable medium according to claim 15, wherein the second axis can be changed to the physical quantity or the condition of the recipe corresponding to the characteristic curve under edit.

18. The computer readable medium according to claim 15, wherein the method of setting the control parameter comprises dragging the characteristic curve to adjust a slope thereof and a projection length to the first axis thereof.

19. The computer readable medium according to claim 15, wherein the working area comprises a plurality of nodes for marking the start and end of the procedure.

20. The computer readable medium according to claim 15, further comprising performing a verification procedure on the recipe, wherein the verification procedure comprises checking for each procedure if at least one of the first condition and second condition is satisfied, the first condition being each control parameter of the procedure of the recipe is reasonable, and the second condition being the order of the characteristic curves is correct.

21. The computer readable medium according to claim 20, wherein the verification procedure further comprises determining if the procedure of the recipe comprises any macro object, and if so, resolving the macro object.

22. The computer readable medium according to claim 20, wherein checking for the first condition comprises determining if the slope of each characteristic curve is smaller than a threshold; and determining if the setting point of each characteristic curve is between a high bound threshold and a low bound threshold.

23. The computer readable medium according to claim 22, wherein the threshold, the high bound threshold, and the low bound threshold are set in a machine setting initialization procedure of the semiconductor equipment or the photoelectric equipment.

24. The computer readable medium according to claim 20, wherein if the recipe fails the verification procedure, each error position is marked on the chart.

25. The computer readable medium according to claim 15, wherein the template area further comprises a plurality of critical symbols which can be set to indicate the control flow in the recipe; and the critical symbol comprises a condition symbol, a loop start symbol, and a loop end symbol.

26. The computer readable medium according to claim 15, further comprises adding to the procedure of the recipe an additional control object or macro object by way of insertion.

27. The computer readable medium according to claim 15, wherein each characteristic curve in the working area has a different color, a different line style, or a different line width.

28. The computer readable medium according to claim 15, further comprising a conversion procedure for converting each characteristic curve in the chart and the corresponding control parameter into source code in text format or form format, or into object code readable by the semiconductor equipment or the photoelectric equipment.
